(19) United States
(12) Patent Application Publication
(10) Pub. No.: US 2006/0216502 A1
(43) Pub. Date: Sep. 28, 2006

(54) Bonding sheet and on-side metal-clad laminate

(76) Inventors: Takashi Kikuchi, Otsu--shi (JP); Naoki Hase, Otsu-shi (JP); Hiroyuki Tsuji, Otsu-shi (JP); Yasuo Fushiki, Kyoto-shi (JP)

Correspondence Address: HOGAN & HARTSON L.L.P., 500 S. GRAND AVENUE, SUITE 1900, LOS ANGELES, CA, 90071-2611, US

(21) Appl. No.: 10/541,081

(22) PCT Filed: Dec. 8, 2003
(86) PCT No.: PCT/JP03/15683

§ 371 Date: Mar. 21, 2006

(30) Foreign Application Priority Data
Jan. 9, 2003 (JP) 2003-2919

(51) Int. Cl. B32B 7/12

(52) U.S. Cl. 428/343

(57) ABSTRACT

A bonding sheet that can be bonded with a metal foil by thermal lamination and has excellent adhesiveness and reduced warpage, and a one-side metal-clad laminate are provided. A bonding sheet has an adhesive layer containing a thermoplastic resin disposed on one side of a heat resistant film and a non-adhesive layer containing a non-thermoplastic resin and a thermoplastic resin disposed on the other side of the heat resistant film. The ratio of the non-thermoplastic resin to the thermoplastic resin in the non-adhesive layer is 82/18 to 97/3 on a weight basis.

### TECHNICAL FIELD

The present invention relates to a bonding sheet having an adhesive layer on one side only and to a flexible one-side metal-clad laminate produced by bonding a metal foil onto this bonding sheet. In particular, the present invention relates to a bonding sheet that can be bonded with a metal foil using a thermal laminator and has reduced warpage and to a flexible one-side metal-clad laminate that is produced by bonding a metal foil onto this bonding sheet and has reduced warpage.

### BACKGROUND ART

Recent years have seen rapid development of electronic devices with higher performance, advanced functions, and smaller size. The development also required electronic components used in these electronic devices to achieve size and weight reduction. Materials for such electronic components are also required to achieve various characteristics such as heat resistance, mechanical strength, electrical characteristics, etc., and techniques for packaging semiconductor elements and wiring boards on which the semiconductor elements are mounted are also required to achieve higher density, advanced functions, and higher performance. With respect to flexible printed circuit boards (hereinafter simply referred to as “FPCs”), fine wiring process, lamination, and the like are conducted, and there has been emergence of component-mounting FPCs for directly mounting components on FPCs, double-sided FPCs having circuits formed on both sides, and multilayer FPCs constituted from laminated FPCs with interlayer wirings. In general, a FPC is constituted from a flexible, thin base film, a circuit pattern formed on the base film, and a cover layer that covers the surface. In order to produce FPCs having above-described characteristics, the performance of the materials such as insulating adhesives and insulating organic films must be improved more. In particular, high heat resistance, high mechanical strength, high processability, high adhesiveness, low moisture absorption, good electrical characteristics, and high dimensional stability are desired. Epoxy resins and acrylic resins currently employed have good processability in a low-temperature range and workability, but their other characteristics are unsatisfactory at the present.

In order to overcome the above-described problems, a double layer FPC having an adhesive layer also composed of a polyimide material has been proposed (e.g., Japanese Unexamined Patent Application Publication No. 2-180682). Examples of the method for making the double layer FPC include a casting method of casting a solution of a polyimide copolymer or a polyamic acid copolymer onto a conductive layer and drying the cast solution to prepare an insulating layer (e.g., Japanese Unexamined Patent Application Publication No. 3-104185), a sputtering method of forming a conductor thin layer by vapor deposition or sputtering and then forming a thick conductor layer by plating (e.g., Japanese Unexamined Patent Application Publication No. 5-327207), and a lamination method of casting a solution of a polyimide copolymer or a polyamic acid copolymer onto an insulating film, drying the cast solution to obtain a bonding sheet, and bonding a conductor layer thereon (e.g., Japanese Unexamined Patent Application Publication No. 2001-129918).

Among these methods, the sputtering method has problems such as high equipment cost, frequent occurrence of pinholes during thin layer formation, and difficulty in attaining sufficient adhesion between the insulating layer and the conductor layer. The casting method has problems such as difficulty of using a thin conductor layer (the conductor layer cannot withstand the load of the solution and undergoes rupture during the casting) and difficulty in preparing a thick insulating layer (the number of times of casting increases, and thereby the cost increases).

Although the lamination method is free of such problems, it is difficult to prepare a one-side metal-clad laminate by the lamination method. In detail, the lamination method has a problem in which, when a metal foil is bonded onto an insulating film having adhesive layers without providing a metal foil on one side, the exposed adhesive layer at that side sticks to a lamination roll, a press plate, or the like. When the adhesive layer at the side not provided with a metal foil is removed to avoid this problem, the balance in linear expansion coefficient of the bonding sheet is impaired, thereby leading to warpage of the bonding sheet or the metal-clad laminate. The warpage of the bonding sheet and the metal-clad laminate poses an impediment during formation of circuits or mounting of components. Its adverse effect is particularly severe in high-density circuit boards.

### DISCLOSURE OF INVENTION

The present invention has been made in view of the above-described problems. An object of the present invention is to provide a bonding sheet that can be processed by a lamination method and that has reduced warpage, and a flexible one-side metal-clad laminate prepared by bonding a metal foil onto the bonding sheet.

The present inventors-have conducted extensive researches to overcome the above-described problems and found that a bonding sheet having an adhesive layer at one side of a heat resistant film and a non-adhesive layer at the other side of the heat resistant film is usable in the lamination method. The present invention has thus been made.

That is, a first aspect of the present invention relates to a bonding sheet including an adhesive layer containing a thermoplastic resin disposed on one side of a heat resistant film and a non-adhesive layer containing a non-thermoplastic resin and a thermoplastic resin disposed on the other side of the heat resistant film.

A preferred embodiment relates to the above bonding sheet in which the ratio of the non-thermoplastic resin to the thermoplastic resin in the non-adhesive layer is 82/18 to 97/3 on a weight basis.

A more preferred embodiment relates to any one of the bonding sheets described above, in which the heat resistant film is a polyimide film.

A yet more preferred embodiment relates to any one of the bonding sheets described above, in which the thermoplastic resin in the adhesive layer and the non-thermoplastic resin and the thermoplastic resin in the non-adhesive layer are polyimides.

A still more preferred embodiment relates to any one of the bonding sheets described above, in which a rectangular piece having a width of 7 cm and a length of 20 cm taken from the bonding sheet exhibits a warpage of 0.5 mm or less at each of the four corners after being left to stand at 20° C. and 60% R.H. for 12 hours.

A most preferred embodiment relates to any one of the bonding sheets described above, in which the linear expansion coefficient (200° C. to 300° C.) of the bonding sheet is in the range of α0±5 (ppm/° C.) wherein α0 (ppm/° C.) is a linear expansion coefficient (200° C. to 300° C.) of a metal foil to be bonded onto the bonding sheet.

A second aspect of the present invention relates to a flexible one-side metal-clad laminate including a metal foil bonded onto the adhesive layer of any of the bonding sheets described above.

A preferred embodiment relates to the flexible one-side metal-clad laminate, in which the metal foil is bonded onto the bonding sheet using a thermal roll laminator including at least one pair of metal rolls.

A more preferred embodiment relates to any one of the flexible one-side metal-clad laminates described above, in which the metal foil is a copper foil.

A yet more preferred embodiment relates to any one of the flexible. one-side metal-clad laminates described above, in which a rectangular piece having a width of 7 cm and a length of 20 cm taken from the flexible one-side metal-clad laminate exhibits a warpage of 1.0 mm or less at each of the four corners after being left to stand at 20° C. and 60% R.H. for 12 hours.

The present invention has been made to overcome the problems described above. An object thereof is to provide a bonding sheet that can be processed by a lamination method and that has reduced warpage, and a flexible one-side metal-clad laminate prepared by bonding a metal foil onto the bonding sheet.

An embodiment of the present invention will now be described.

A bonding sheet of the present invention has an adhesive layer containing a thermoplastic resin disposed on one surface of a heat resistant film and a non-adhesive layer containing a non-thermoplastic resin and a thermoplastic resin disposed on the other surface of the film.

Here, the term “heat resistant” means that a film can withstand use at a heating temperature during thermal lamination. Accordingly, the heat resistant film may be any film that has the above-described property, and various known resin films may be used. Among these films, polyimide films, such as Apical (produced by Kaneka Corporation), Kapton (produced by Dupont-Toray Co., Ltd.), and Upilex (produced by Ube Industries, Ltd.), having not only excellent heat resistance but also excellent physical characteristics such as electrical characteristics are preferable for the use. The temperature of heating during the thermal lamination, i.e., the bonding temperature, generally varies according to the lamination conditions, such as pressure and speed. The bonding temperature is generally in the range of about 150° C. to 400° C. since lamination using existing equipment is possible. Preferably, the bonding temperature is at least 50° C. higher and more preferably at least 100° C. higher than the glass transition temperature (Tg) of the bonding sheet, as described below.

The “non-adhesive layer” disposed on one surface of the heat resistant film is a layer that shows substantially no adhesiveness to a process material, such as metal rolls, press plates, and protective materials.

The thermoplastic resin in the adhesive layer or the non-adhesive layer of the inventive bonding sheet is not particularly limited as long as it has heat resistance. Preferable examples thereof include thermoplastic polyimides, thermoplastic polyamideimides, thermoplastic polyetherimides, and thermoplastic polyesterimides. Among these, thermoplastic polyesterimides are particularly preferable for their low moisture absorption.

The thermoplastic resin in the present invention preferably has a glass transition temperature (Tg) in the range of 150° C. to 300° C. since such a resin can be laminated using existing equipment and does not impair the heat resistance of the resulting metal-clad laminate. Note that Tg can be determined from the inflection point of storage modulus measured with a dynamic mechanical analyzer (DMA).

The “non-thermoplastic resin” contained in the non-adhesive layer of the inventive bonding sheet refers to a resin having either no substantial Tg or a glass transition temperature (Tg) in a temperature range higher than the temperature range in which a metal foil can be bonded to the bonding sheet using a thermal laminator.

The non-thermoplastic resin in the non-adhesive layer of the bonding sheet is not particularly limited as long as it is heat resistant. Examples thereof include polyimides, polyamideimides, polyetherimides, and polyester imides. As described below, in order to control the linear expansion coefficient of the bonding sheet as a whole, the linear expansion coefficient of the non-adhesive layer and that of the adhesive layer are preferably controlled to about the same level. Thus, it is preferable to use a resin with a linear expansion coefficient as high as possible as the non-thermoplastic resin in the non-adhesive layer. In particular, a most typical polyimide made of 4,4′-diaminodiphenyl ether and a pyromellitic dianhydride is preferable since it has a linear expansion coefficient of about 30 ppm and is relatively inexpensive and easily available for polyimides.

Although these non-thermoplastic resins may be singly used to form a non-adhesive layer, the adhesiveness thereof to the heat resistant film is low, thereby making it difficult to use as the bonding sheet. Even when a composition having a linear expansion coefficient as high as possible is selected as the non-thermoplastic resin as described above, the difference in linear expansion coefficient between the non-thermoplastic resin in the non-adhesive layer and the thermoplastic resin in the adhesive layer is generally large. Thus, it is still difficult to attain a good balance of linear expansion coefficient between the adhesive layer and the non-adhesive layer.

The present inventors have found that the above-described problem can be overcome when the non-adhesive layer of the bonding sheet is composed of a mixture of a non-thermoplastic resin and a thermoplastic resin. In other words, this arrangement prevents adhesion to the rolls and the like during the lamination while securing the adhesiveness to the heat resistant film and adjusting the linear expansion coefficient of the non-adhesive layer to substantially the same level as the linear expansion coefficient of the adhesive layer. Thus, it becomes easier to attain a good balance of linear expansion coefficient between the adhesive layer and the non-adhesive layer.

The mixing ratio described above between the non-thermoplastic resin and the thermoplastic resin in the non-adhesive layer is preferably set to a level that can maintain adhesiveness to a heat resistant base film and yet exhibits no adhesiveness to the process material, such as metal rolls. In particular, the mixing ratio of the non-thermoplastic resin to the thermoplastic resin on a weight basis is preferably 82/18 to 97/3 and more preferably 85/15 to 95/5. When the ratio of the thermoplastic resin is less than 3 percent by weight, the adhesiveness to the heat resistant film is insufficient, and troubles may occur during processing or during actual use.

On the contrary, when the ratio of the thermoplastic resin is more than 18 percent by weight, the non-adhesive layer exhibits adhesiveness. Thus, a problem of sticking and the like may occur during lamination. The mixing ratio depends on the composition of the resin; however, it is generally preferable to set the mixing ratio to the above-described range since the linear expansion coefficient of the non-adhesive layer becomes close to that of the adhesive layer. Moreover, it is preferable to set the linear expansion coefficient α1 (ppm/° C.) of the non-adhesive layer and the linear expansion coefficient α2 (ppm/° C.) of the adhesive layer to satisfy (α2−15)≦α1≦α2. When the linear expansion coefficient of the non-adhesive layer is within the above described range, it becomes possible to control the linear expansion coefficient of the bonding sheet as a whole (described below) by controlling the thickness balance between the adhesive layer and the non-adhesive layer. When the linear expansion coefficient of the non-adhesive layer is outside the above-described range, i.e., when the linear expansion coefficient of the non-adhesive layer is significantly smaller than that of the adhesive layer, the thickness of the non-adhesive layer must be made substantially larger than that of the adhesive layer, which is a problem.

To be more specific, a solvent cannot be completely removed during the drying step or appearance may be impaired due to foaming.

The method for making the inventive bonding sheet is not particularly limited. In making the three-layer bonding sheet described above, the sheet may be made by a method of respectively forming an adhesive layer and a non-adhesive layer on the two surfaces of a heat resistant core film either simultaneously or one surface at a time, or by a method of bonding an adhesive layer and a non-adhesive layer previously formed into sheets onto surfaces of the core film. Alternatively, resins of adhesive layer/core film/non-adhesive layer may be coextruded to substantially form a laminate in one step to thereby prepare a bonding sheet.

For example, when a polyimide resin is used in the adhesive layer, a thermoplastic polyimide resin or a resin solution prepared by dissolving or dispersing the thermoplastic polyimide resin in an organic solvent may be applied on the surface of the core film. Alternatively, a solution of polyamic acid, i.e., the precursor of the thermoplastic polyimide, may be prepared and applied on the surface of the core film, followed by imidization. Here, the conditions for the synthesis and imidization of polyamic acid are not particularly limited, and known materials and conditions, and the like may be employed (for example, see the examples described below). The polyamic acid solution may contain other materials, such as a coupling agent, a filler, and the like, depending on the usage.

On the other hand, when a polyimide resin is used as the non-thermoplastic resin and the thermoplastic resin in the non-adhesive layer, it is preferable to employ a method in which a mixture of a polyamic acid, i.e., a precursor, and a thermoplastic polyimide or its precursor is applied onto the surface of the core film, followed by imidization because it is difficult to dissolve the non-thermoplastic polyimide in an organic solvent. The imidization conditions are not particularly limited. Thermal curing is preferred to chemical curing since the resulting polyimide shows a larger linear expansion coefficient. The non-adhesive layer may also contain other materials, e.g., a coupling agent and a filler, depending on the usage.

The thickness of each layer may be adjusted as required so that the total thickness is adjusted to suit the usage. It is preferable to control the thickness balance between the adhesive layer and the non-adhesive layer while taking into account the linear expansion coefficient of each layer so that warpage does not occur in the resulting bonding sheet. Here, it is possible to prepare a composition that can yield a linear expansion coefficient of the adhesive layer and that of the non-adhesive layer at substantially the same level by using a non-thermoplastic resin having a relatively large linear expansion coefficient or by selecting imidization conditions, as described above. In this manner, it becomes easier to achieve a good balance in thickness.

The warpage of the resulting bonding sheet can be reduced by adjusting the composition of the non-adhesive layer and the thickness balance between the adhesive layer and the non-adhesive layer.

In particular, for a rectangular bonding sheet 7 cm in width and 20 cm in length, the warpage at each of the four corners after the sheet is being left to stand at 20° C. and 60% R.H. for 12 hours is preferably 0.5 mm or less. When the warpage of the bonding sheet is within this range, the warpage of a circuit board constituted from a metal-clad laminate made from this bonding sheet and a circuit formed by etching can be reduced, and component mounting becomes easier.

The linear expansion coefficient (200° C. to 300° C.) of the bonding sheet as a whole is preferably adjusted in the range of α0±5 (ppm/° C.), wherein α0 is a linear expansion coefficient (ppm/° C.) (200° C. to 300° C.) of a metal foil, since the warpage of the metal-clad laminate prepared by bonding the metal foil onto the inventive bonding sheet can be reduced. Note that the linear expansion coefficient of the bonding sheet as a whole can be calculated by the formula disclosed in Japanese Unexamined Patent Application Publication No. 2000-174154, for example.

In the present invention, the metal foil is not particularly limited. When the inventive flexible one-side metal-clad laminate is used in electronic and electrical devices, the metal foil may be, for example, a foil composed of copper, a copper alloy, stainless steel, a stainless steel alloy, nickel, a nickel alloy (including alloy 42), aluminum, or an aluminum alloy. For typical flexible laminates, copper foils, such as rolled copper foils and electrolytic copper foils, are widely used, and such copper foils are also preferable for the present invention. Note that an antirust layer, a heat resistant layer, or an adhesive layer may be disposed on the surface of the metal foil. The thickness of the metal foil is not particularly limited and should be sufficient to exhibit satisfactory functions.

The inventive one-side metal-clad laminate may be prepared by bonding a metal foil onto an adhesive layer of the bonding sheet. Examples of the techniques for bonding the metal foil onto the bonding sheet include a batch processing technique using a single-plate press and a continuous pressing technique by hot roll lamination or double belt pressing (DBP). From the standpoints of productivity and equipment cost including cost of maintenance, a technique that uses a hot roll laminator including at least one pair of metal rolls is preferable. Here, the “hot roll laminator including at least one pair of metal rolls” may be any equipment having metal rolls for applying heat and pressure to the material. The specific configuration of the equipment is not particularly limited.

The specific structure of the above-described means for carrying out the thermal lamination is not particularly limited. Preferably, a protective material is interposed between the pressed surface and the metal foil to improve the appearance of the resulting laminate. The protective material may be any material that can withstand the heating temperature during the thermal lamination step. A heat resistant plastic, such as a non-thermoplastic polyimide film, or a metal foil, such as a copper foil, an aluminum foil, or a stainless steel foil, is preferably used. Among these, a non-thermoplastic polyimide film is more preferred since the film achieves a good balance between heat resistance, reusability, and the like.

The technique for heating the materials to be laminated for the thermal lamination means described above is not particularly limited. For example, heating means capable of heating at a predetermined temperature and employing a known technique, such as a heat circulation technique, a hot air heating technique, and an induction heating technique, may be used. Similarly, the technique for pressing the materials to be laminated in the above-described thermal lamination means is not particularly limited. For example, pressing means that can apply a predetermined pressure and employs a known technique, such as a hydraulic technique, an air pressure technique, or a gap-frame pressing technique, may be employed.

The heating temperature during the thermal lamination step described above, i.e., the lamination temperature, is preferably at least 50° C. higher and more preferably at least 100° C. higher than the glass transition temperature (Tg) of the bonding sheet. At a lamination temperature of Tg +50° C. or higher, the metal foil can be satisfactorily laminated onto the bonding sheet by thermal lamination. At a lamination temperature of Tg +100° C. or higher, the lamination rate can be increased to further increase the productivity.

The lamination rate during the thermal lamination step is preferably at least 0.5 m/min and more preferably at least 1.0 m/min. At a lamination rate of 0.5 m/min or more, sufficient thermal lamination is possible. At a lamination rate of 1.0 m/min or more, the productivity can be further increased.

As the pressure during the thermal lamination step, i.e., the lamination pressure, increases, the lamination temperature can be advantageously decreased and the lamination rate can be advantageously increased. In general, at an excessively high lamination pressure, the dimensional stability of the resulting laminate tends to degrade. On the contrary, at an excessively low lamination pressure, the adhesive strength of the metal foil of the resulting laminate is decreased. Thus, the lamination pressure is preferably in the range of 49 to 490 N/cm (5 to 50 kgf/cm) and more preferably in the range of 98 to 294 N/cm (10 to 30 kgf/cm). Within this range, three conditions, i.e., the lamination temperature, the lamination rate, and the lamination pressure, are satisfactory, and the productivity can be further increased.

In making a one-side metal-clad laminate of the present invention, a thermal laminator that continuously heats the materials to be laminated while applying pressure may be used. Material unreeling means for unreeling the materials to be laminated may be disposed upstream of a thermal lamination means of the thermal laminator, and material reeling means for reeling the laminated materials may be disposed downstream of the thermal lamination means. These means can further increase the productivity of the thermal laminator. The structures of the material unreeling means and the material reeling means are not particularly limited. For example, a known roll-type reel that can take up a bonding sheet, a metal foil, or a resulting laminate, may be employed.

More preferably, protective material reeling means and protective material unreeling means for reeling and unreeling a protective material are provided. With these protective material reeling and unreeling means, the protective material used in the thermal lamination step can be reeled and again set to the unreeling side so that the protective material can be reused. Moreover, end position detecting means and reeling position adjusting means may be provided to align the two ends of the protective material. In this manner, the protective material can be accurately reeled with its ends aligned, thereby increasing the efficiency of the reuse.

The structures of the protective material reeling means, the protective material unreeling means, the end position detecting means, and the reeling position adjusting means are not particularly limited. Various known devices may be employed.

By controlling the linear expansion coefficient of the bonding sheet as a whole, the warpage of the resulting one-side metal-clad laminate can be reduced. In particular, for a rectangular flexible one-side metal-clad laminate 7 cm in width and 20 cm in length, the warpage at each of the four corners after being left to stand at 20° C. and 60% R.H. for 12 hours is preferably 1.0 mm or less. When the warpage of the one-side metal-clad laminate is within this range, the warpage that occurs during the conveying in the process and the warpage of the circuit board having a circuit formed by etching can be reduced.

### BEST MODE FOR CARRYING OUT THE INVENTION

### EXAMPLES

The present invention will now be specifically described by way of examples. The present invention is not limited by these examples.

The methods for evaluating the linear expansion coefficient, the metal foil peeling strength, the warpage, and the lamination of EXAMPLES and COMPARATIVE EXAMPLES are as follows.

(Linear Expansion Coefficient)

The linear expansion coefficient was measured with a Thermo Stress Strain Measurement Instrument TMA120C produced by Seiko Instruments Inc., under nitrogen stream at a heating rate of 10° C./min in the temperature range of 10° C. to 330° C. The linear expansion coefficients in the temperature range of 200° C. to 300° C. were averaged.

(Metal Foil Peeling Strength)

A sample was prepared according to Japanese Industrial Standards (JIS) C6471, “6.5 Peeling Strength”. A metal foil portion 5 mm in width was peeled at a peeling angle of 180° and at a rate of 50 mm/min to measure the load.

(Warpage)

The warpage of the bonding sheet and the one-side metal-clad laminate was measured as follows. (1) Each sample was cut into a 7 cm×20 cm piece. (2) Each piece was left to stand at 20° C. and 60% R.H. for 12 hours. (3) The height of the warpage at each of the four corners of the sample piece was measured with a microscope equipped with a microgauge. The metal-clad laminate was placed with the metal foil surface up.

(Lamination)

A sample that was satisfactorily laminated without problems of sticking, separation, or the like was evaluated as good (◯), a sample that was laminated with a moderate degree of sticking, separation, or the like was evaluated as fair (Δ), and a sample that could not be laminated due to sticking or the like or that caused troubles during the use of the laminate was evaluated as poor (x).

In EXAMPLES 1 to 7, and COMPARATIVE EXAMPLES 1 to 4, polyamic acid, which was a precursor of the thermoplastic polyimide or the non-thermoplastic polyimide used in the bonding sheet, was synthesized according to one of SYNTHETIC EXAMPLES 1 to 5 below.

### Synthetic Example 1

### Synthesis of Non-Thermoplastic Polyimide Precursor

To a 2,000 mL glass flask, 615 g of N,N-dimethylformamide (hereinafter referred to as DMF) and 88.1 g of 4,4′-diamino diphenyl ether (hereinafter referred to as ODA) were added. While stirring the resulting mixture under nitrogen atmosphere, 93.8 g of pyromellitic dianhydride (hereinafter referred to as PMDA) was added. The resulting mixture was stirred in an ice bath for 30 minutes. A solution of 2.2 g of PMDA in 35 g of DMF was separately prepared and gradually added to the above-described reaction solution while monitoring the viscosity under stirring. The addition and stirring were discontinued after the viscosity reached 5,000 poise, thereby obtaining a polyamic acid solution.

### Synthetic Example 2

### Synthesis of Thermoplastic Polyimide Precursor

To a 1,000 mL glass flask, 432 g of DMF and 82.2 g of bis[4-(4-aminophenoxy)phenyl]sulfone (hereinafter referred to as BAPS) were added. While stirring the mixture under nitrogen atmosphere, 53.0 g of 3,3′,4,4′-biphenyltetracarboxylic acid dianhydride (hereinafter referred to as BPDA) was added, followed by 30 minutes of stirring in an ice bath. A solution of 2.9 g of BPDA in 30 g of DMF was separately prepared and gradually added to the above-described reaction solution while monitoring the viscosity under stirring. The addition and stirring were discontinued after the viscosity reached 3,000 poise, thereby obtaining a polyamic acid solution.

### Synthetic Example 3

### Synthesis of Thermoplastic Polyimide Precursor

To a 1,000 mL glass flask, 650 g of DMF and 82.1 g of 2,2′-bis[4-(4-aminophenoxy)phenyl]propane (hereinafter referred to as BAPP) was added. While stirring the mixture under nitrogen atmosphere, 22.6 g of 3,3′4,4′-benzophenonetetracarboxylic acid dianhydride (hereinafter referred to as BTDA) was gradually added. Subsequently, 49.2 g of 3,3′,4,4′-ethylene glycol dibenzoate tetracarboxylic acid dianhydride (hereinafter referred to as TMEG) was added, and the resulting mixture was stirred in an ice bath for 30 minutes. A solution of 4.1 g of TMEG in 35 g of DMF was separately prepared and gradually added to the above-described reaction solution while monitoring the viscosity under stirring. The addition and stirring were discontinued after the viscosity reached 3,000 poise, thereby obtaining a polyamic acid solution.

### Synthetic Example 4

### Synthesis of Thermoplastic Polyimide Precursor

To a 1,000 mL glass flask, 740 g of DMF and 82.1 g of BAPP were added. While stirring the mixture under nitrogen atmosphere, 40.3 g of 2,2′-bis(hydroxyphenyl)propane dibenzoate tetracarboxylic acid dianhydride (hereinafter referred to as ESDA) was gradually added. Subsequently, 49.2 g of TMEG was added, and the resulting mixture was stirred in an ice bath for 30 minutes. A solution of 4.1 g of TMEG in 30 g of DMF was separately prepared and gradually added to the above-described reaction solution while monitoring the viscosity under stirring. The addition and stirring were discontinued after the viscosity reached 3,000 poise, thereby obtaining a polyamic acid solution.

### Synthetic Example 5

### Synthesis of Thermoplastic Polyimide Precursor

To a 1,000 mL glass flask, 600 g of DMF and 82.1 g of BAPP were added. While the mixture was stirred under nitrogen atmosphere, 53.0 g of BPDA was gradually added.

Subsequently, 4.1 g of TMEG was added, and the mixture was stirred in an ice bath for 30 minutes. A solution of 4.1 g of TMEG in 20 g of DMF was separately prepared and gradually added to the above-described reaction solution while monitoring the viscosity. The addition and stirring were discontinued after the viscosity reached 3,000 poise, thereby obtaining a polyamic acid solution.

### Example 1

The polyamic acid solution obtained in SYNTHETIC EXAMPLE 3 was diluted with DMF to a solid content of 10 percent by weight. The polyamic acid was then applied on one side of a polyimide film (Apical 17HP, produced by Kaneka Corporation) so that the final one-side thickness of the thermoplastic polyimide layer was 4 μm and then heated at 120° C. for 4 minutes (adhesive layer side). On the other hand, the polyamic acid solution obtained in SYNTHETIC EXAMPLE 1 and the polyamic acid solution obtained in SYNTHETIC EXAMPLE 3 were mixed so that the weight ratio of the solid content was 90:10. The mixture was then diluted with DMF to a solid content of 10 percent by weight. The resulting solution was applied on the other side of the film so that the final one-side thickness was 4 μm and then heated at 120° C. for 4 minutes (non-adhesive layer side). Imidization was performed by heating at 380° C. for 20 seconds to obtain a bonding sheet. The linear expansion coefficient of this bonding sheet in the temperature range of 200° C. to 300° C. was 20 ppm/° C.

An 18-μm rolled copper foil (BHY-22B-T, produced by Japan Energy Corporation, linear expansion coefficient: 19 ppm/° C.) was placed on the adhesive layer surface (the surface coated with the polyamic acid obtained in SYNTHETIC EXAMPLE 3) of the resulting bonding sheet. Protective materials (Apical 125NPI, produced by Kaneka Corporation, linear expansion coefficient: 16 ppm/° C.) were then placed on both sides of the bonding sheet. Thermal lamination was conducted with a thermal roll laminator at a lamination temperature of 300° C., a lamination pressure of 196 N/cm (20 kgf/cm), and a lamination rate of 1.5 m/min, thereby obtaining a flexible one-side metal-clad laminate of the present invention.

### Example 2

The polyamic acid solution obtained in SYNTHETIC EXAMPLE 3 was diluted with DMF to a solid content of 10 percent by weight. The polyamic acid was applied on one side of the polyimide film (Apical 17HP, produced by Kaneka Corporation) so that the final one-side thickness of the thermoplastic polyimide layer was 4 μm and heated at 120° C. for 4 minutes (adhesive layer side). The polyamic acid solution obtained in SYNTHETIC EXAMPLE 1 and the polyamic acid solution obtained in SYNTHETIC EXAMPLE 3 were mixed so that the weight ratio of the solid content was 85:15. The mixture was diluted with DMF to a solid content of 10 percent by weight. The resulting polyamic acid solution was applied on the other side of the film so that the final one-side thickness was 4 μm and heated at 120° C. for 4 minutes (non-adhesive layer side). Imidization was conducted by heating at 380° C. for 20 seconds to obtain a bonding sheet. The linear expansion coefficient of the bonding sheet in the temperature range of 200° C. to 300° C. was 19 ppm/° C. The resulting bonding sheet was subjected to thermal lamination as in EXAMPLE 1 to prepare a flexible one-side metal-clad laminate of the present invention.

### Example 3

The polyamic acid solution obtained in SYNTHETIC EXAMPLE 3 was diluted with DMF to a solid content of 10 percent by weight and applied on one side of a polyimide film (Apical 17HP, produced by Kaneka Corporation) so that the final one-side thickness of the thermoplastic polyimide layer was 4 μm, followed by heating at 120° C. for 4 minutes (adhesive layer side). The polyamic acid solution obtained in SYNTHETIC EXAMPLE 1 and the polyamic acid solution obtained in SYNTHETIC EXAMPLE 3 were mixed so that the weight ratio of the solid content was 95:5. The mixture was diluted with DMF to a solid content of 10 percent by weight. The resulting solution was applied on the other side of the film so that the final one-side thickness was 4 μm and heated at 120° C. for 4 minutes (non-adhesive layer side). Imidization was conducted by heating at 380° C. for 20 seconds to obtain a bonding sheet. The linear expansion coefficient of this bonding sheet in the temperature range of 200° C. to 300° C. was 20 ppm/° C. The bonding sheet was subjected to thermal lamination as in EXAMPLE 1 to prepare a flexible one-side metal-clad laminate of the present invention.

### Example 4

A bonding sheet was prepared as in EXAMPLE 1 except that the polyamic acid solution prepared in SYNTHETIC EXAMPLE 4 was used instead of the polyamic acid solution prepared in SYNTHETIC EXAMPLE 3. The linear expansion coefficient of this bonding sheet in the temperature range of 200° C. to 300° C. was 20 ppm/° C. The bonding sheet was subjected to thermal lamination as in EXAMPLE 1 to prepare a flexible one-side metal-clad laminate of the present invention.

### Example 5

A bonding sheet was prepared as in EXAMPLE 1 except that the polyamic acid solution prepared in SYNTHETIC EXAMPLE 5 was used instead of the polyamic acid solution prepared in SYNTHETIC EXAMPLE 3. The linear expansion coefficient of this bonding sheet in the temperature range of 200° C. to 300° C. was 19 ppm/° C. The bonding sheet was subjected to thermal lamination as in EXAMPLE 1 but with a lamination temperature of 380° C. to prepare a flexible one-side metal-clad laminate of the present invention.

### Example 6

The polyamic acid solution prepared in SYNTHETIC EXAMPLE 3 was diluted with DMF to a solid content of 10 percent by weight. The polyamic acid solution was applied on one side of a polyimide film (Apical 17HP, produced by Kaneka Corporation) so that the final one-side thickness of the thermoplastic polyimide layer was 4 μm, followed by heating at 120° C. for 4 minutes (adhesive layer side). The polyamic acid solution obtained in SYNTHETIC EXAMPLE 1 and the polyamic acid solution obtained in SYNTHETIC EXAMPLE 3 were mixed so that the weight ratio of the solid content was 80:20. The mixture was diluted with DMF to a solid content of 10 percent by weight. The resulting solution was applied on the other side of the film so that the final one-side thickness was 4 μm and heated at 120° C. for 4 minutes (non-adhesive layer side). Imidization was conducted by heating at 380° C. for 20 seconds to obtain a bonding sheet. The linear expansion coefficient of this bonding sheet in the temperature range of 200° C. to 300° C. was 20 ppm/° C. The bonding sheet was subjected to thermal lamination as in EXAMPLE 1 to prepare a flexible one-side metal-clad laminate of the present invention.

### Example 7

The polyamic acid solution obtained in SYNTHETIC EXAMPLE 3 was diluted with DMF to a solid content of 10 percent by weight and applied on one side of a polyimide film (Apical 17HP, produced by Kaneka Corporation) so that the final one-side thickness of the thermoplastic polyimide layer was 4 μm, followed by heating at 120° C. for 4 minutes (adhesive layer surface). The polyamic acid solution obtained in SYNTHETIC EXAMPLE 1 and the polyamic acid solution obtained in SYNTHETIC EXAMPLE 3 were mixed so that the weight ratio of the solid content was 98:2. The mixture was diluted with DMF to a solid content of 10 percent by weight. The resulting solution was applied on the other side of the film so that the final one-side thickness was 4 μm and heated at 120° C. for 4 minutes (non-adhesive layer side). Imidization was conducted by heating at 380° C. for 20 seconds to obtain a bonding sheet. The linear expansion coefficient of this bonding sheet in the temperature range of 200° C. to 300° C. was 20 ppm/° C. The bonding sheet was subjected to thermal lamination as in EXAMPLE 1 to prepare a flexible one-side metal-clad laminate of the present invention.

The results of the evaluation of the bonding sheets and the metal-clad laminates obtained in EXAMPLES and COMPARATIVE EXAMPLES are shown in Table 1. The bonding sheets of the present invention had controlled linear expansion coefficients and were usable in the thermal lamination method since a non-adhesive layer of a particular composition was provided. The warpage was also reduced. As a result, the one-side metal-clad laminates prepared therefrom did not experience warpage and exhibited excellent adhesiveness.

### Comparative Example 1

The polyamic acid solution obtained in SYNTHETIC EXAMPLE 3 was diluted with DMF to a solid content of 10 percent by weight. The polyamic acid was applied on both sides of a polyimide film (Apical 17HP, produced by Kaneka Corporation) so that the final one-side thickness of the thermoplastic polyimide layer was 4 μm and then heated at 120° C. for 4 minutes. Imidization was conducted by heating at 380° C. for 20 seconds to obtain a bonding sheet. The linear expansion coefficient of this bonding sheet in the .temperature range of 200° C. to 300° C. was 20 ppm/° C. The bonding sheet was subjected to thermal lamination as in EXAMPLE 1. The side with no copper foil stuck onto the protective film and could not be separated.

### Comparative Example 2

The polyamic acid solution obtained in SYNTHETIC EXAMPLE 5 was diluted with DMF to a solid content of 10 percent by weight and applied on one side of a polyimide film (Apical 17HP, produced by Kaneka Corporation) so that the final one-side thickness of the thermoplastic polyimide layer was 4 μm, followed by heating at 120° C. for 4 minutes. Subsequently, the polyamic acid solution obtained in SYNTHETIC EXAMPLE 2 was applied on the opposite side in the same manner, dried, and heated at 380° C. for 20 seconds to conduct imidization, thereby obtaining a bonding sheet. The linear expansion coefficient of this bonding sheet in the temperature range of 200° C. to 300° C. was 21 ppm/° C. The bonding sheet was subjected to thermal lamination as in EXAMPLE 1 but with a lamination temperature of 380° C. The side having no copper foil stuck onto the protective film and could not be separated.

### Comparative Example 3

The polyamic acid solution obtained in SYNTHETIC EXAMPLE 3 was diluted with DMF to a solid content of 10 percent by weight and applied on one side of a polyimide film (Apical 17HP, produced by Kaneka Corporation) so that the final one-side thickness of the thermoplastic polyimide layer was 4 μm, followed by heating at 120° C. for 4 minutes (adhesive layer side). Imidization was conducted by heating at 380° C. for 20 seconds to obtain a bonding sheet. The linear expansion coefficient of this bonding sheet in the temperature range of 200° C. to 300° C. was 14 ppm/° C. The bonding sheet was subjected to thermal lamination as in EXAMPLE 1 to prepare a flexible one-side metal-clad laminate.

### Comparative Example 4

The polyamic acid solution obtained in SYNTHETIC EXAMPLE 3 was diluted with DMF to a solid content of 10 percent by weight and applied on one side of a polyimide film (Apical 17HP, produced by Kaneka Corporation) so that the final one-side thickness of the thermoplastic polyimide layer was 4 μm, followed by heating at 120° C. for 4 minutes (adhesive layer surface). The polyamic acid solution obtained in SYNTHETIC EXAMPLE 1 was diluted with DMF to a solid content of 10 percent by weight and the resulting polyamic acid solution was applied onto the other surface of the film so that the final one-side thickness was 4 μm, followed by heating at 120° C. for 4 minutes (non-adhesive layer side). Imidization was conducted by heating at 380° C. for 20 seconds to prepare a bonding sheet. The linear expansion coefficient of this bonding sheet in the temperature range of 200° C. to 300° C. was 20 ppm/° C. The bonding sheet was subjected to thermal lamination as in EXAMPLE 1 to prepare a flexible one-side metal-clad laminate. However, the side of this laminate not provided with a copper foil (the side onto which the polyamic acid solution obtained in SYNTHETIC EXAMPLE 1 was applied and imidized) did not have sufficient adhesiveness to the polyimide film and easily separated.

COMPARATIVE EXAMPLES 1 and 2 show that when the thermoplastic polyimide was disposed on both sides, the side not provided with a copper foil stuck onto the process material during the lamination. COMPARATIVE EXAMPLE 3 shows that although thermal lamination was possible by removing the thermoplastic polyimide layer at the side not provided with a copper foil, the bonding sheet and the laminate obtained suffered from warpage. Moreover, formation of a non-adhesive layer did not lead to sufficient adhesiveness to a core film because the composition of the non-adhesive layer was not adequate, as shown in COMPARATIVE EXAMPLE 4.

TABLE 1

| | | Warpage (mm) | | Adhesion |
|---|---|---|---|---|
| | | Bonding | Metal-clad | strength |
| | Laminate | sheet | laminate | (N/cm) |
| EXAMPLE 1 | ◯ | 0.1 | 0.4 | 7.8 |
| EXAMPLE 2 | ◯ | 0.2 | 0.3 | 7.8 |
| EXAMPLE 3 | ◯ | 0.1 | 0.4 | 7.8 |
| EXAMPLE 4 | ◯ | 0.1 | 0.4 | 7.8 |
| EXAMPLE 5 | ◯ | 0.1 | 0.3 | 9.8 |
| EXAMPLE 6 | Δ | 0.1 | — | — |
| EXAMPLE 7 | Δ | 0.2 | — | — |
| COMPARATIVE | X (sticking) | 0.1 | — | — |
| EXAMPLE 1 | | | | |
| COMPARATIVE | X (sticking) | 0.2 | — | — |
| EXAMPLE 2 | | | | |
| COMPARATIVE | ◯ | 30 | 20 | 7.8 |
| EXAMPLE 3 | | | | |
| COMPARATIVE | X | 0.4 | — | — |
| EXAMPLE 4 | (separation | | | |
| | of non- | | | |
| | adhesive | | | |
| | layer) | | | |

### INDUSTRIAL APPLICABILITY

The side of the inventive bonding sheet not provided with a metal foil exhibits no adhesiveness to a process material during lamination. Thus, sticking to a metal roll or the like can be prevented, and a one-side metal-clad laminate can be fabricated by thermal lamination. Since a good balance of linear expansion coefficient between the adhesive side and non-adhesive side can be achieved, the warpage of the bonding sheet can be reduced. A flexible one-side metal-clad laminate prepared from this bonding sheet not only shows high adhesive strength but also reduces the occurrence of warpage as with the bonding sheet. Thus, the bonding sheet and the flexible one-side metal-clad laminate of the present invention can be suitably used for electronic device applications such as circuit boards of higher-density electronic devices, for example.

1. A bonding sheet comprising an adhesive layer containing a thermoplastic resin disposed on one side of a heat resistant film and a non-adhesive layer containing a non-thermoplastic resin and a thermoplastic resin disposed on the other side of the heat resistant film.

2. The bonding sheet according to claim 1, wherein the ratio of the non-thermoplastic resin to the thermoplastic resin in the non-adhesive layer is 82/18 to 97/3 on a weight basis.

3. The bonding sheet according to claim 1, wherein the heat resistant film is a polyimide film.

4. The bonding sheet according to claim 1, wherein the thermoplastic resin in the adhesive layer and the non-thermoplastic resin and the thermoplastic resin in the non-adhesive layer are polyimides.

5. The bonding sheet according to claim 1, wherein a rectangular piece having a width of 7 cm and a length of 20 cm taken from the bonding sheet exhibits a warpage of 0.5 mm or less at each of the four corners after being left to stand at 20° C. and 60% R.H. for 12 hours.

6. The bonding sheet according to claim 1, wherein the linear expansion coefficient (200° C. to 300° C.) of the bonding sheet is in the range of α0±5 (ppm/° C.) wherein α0 (ppm/° C.) is a linear expansion coefficient (200° C. to 300° C.) of a metal foil to be bonded onto the bonding sheet.

7. A flexible one-side metal-clad laminate comprising a metal foil bonded onto the adhesive layer of the bonding sheet according to claim 1.

8. The flexible one-side metal-clad laminate according to claim 7, wherein the metal foil is bonded onto the bonding sheet using a thermal roll laminator including at least one pair of metal rolls.

9. The flexible one-side metal-clad laminate according to claim 7, wherein the metal foil is a copper foil.

10. The flexible one-side metal-clad laminate according to claim 7, wherein a rectangular piece having a width of 7 cm and a length of 20 cm taken from the flexible one-side metal-clad laminate exhibits a warpage of 1.0 mm or less at each of the four corners after being left to stand at 20° C. and 60% R.H. for 12 hours.

11. The bonding sheet according to claim 2, wherein the heat resistant film is a polyimide film.

12. The bonding sheet according to claim 2, wherein the thermoplastic resin in the adhesive layer and the non-thermoplastic resin and the thermoplastic resin in the non-adhesive layer are polyimides.

13. The bonding sheet according to claim 3, wherein the thermoplastic resin in the adhesive layer and the non-thermoplastic resin and the thermoplastic resin in the non-adhesive layer are polyimides.

14. The bonding sheet according to claim 3, wherein a rectangular piece having a width of 7 cm and a length of 20 cm taken from the bonding sheet exhibits a warpage of 0.5 mm or less at each of the four corners after being left to stand at 20° C. and 60% R.H. for 12 hours.

15. The bonding sheet according to claim 3, wherein the linear expansion coefficient (200° C. to 300° C.) of the bonding sheet is in the range of α0±5 (ppm/° C.) wherein α0 (ppm/° C.) is a linear expansion coefficient (200° C. to 300° C.) of a metal foil to be bonded onto the bonding sheet.

16. The bonding sheet according to claim 5, wherein the linear expansion coefficient (200° C. to 300° C.) of the bonding sheet is in the range of α0±5 (ppm/° C.) wherein α0 (ppm/° C.) is a linear expansion coefficient (200° C. to 300° C.) of a metal foil to be bonded onto the bonding sheet.

17. The bonding sheet according to claim 14, wherein the linear expansion coefficient (200° C. to 300° C.) of the bonding sheet is in the range of α0±5 (ppm/° C.) wherein α0 (ppm/° C.) is a linear expansion coefficient (200° C. to 300° C.) of a metal foil to be bonded onto the bonding sheet.

18. A flexible one-side metal-clad laminate comprising a metal foil bonded onto the adhesive layer of the bonding sheet according to claim 3.

19. The flexible one-side metal-clad laminate according to claim 18, wherein the metal foil is bonded onto the bonding sheet using a thermal roll laminator including at least one pair of metal rolls.
